(19) United States
(12) Patent Application Publication
(10) Pub. No.: US 2007/0077971 A1
(43) Pub. Date: Apr. 5, 2007

(54) Hinge assembly for a foldable electronic device

(75) Inventors: Ying-Liang Tu, Shenzhen (CN); Shun Guo, Shenzhen (CN); Chia-Hua Chen, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO., LTD, Shindian City (TW)

(21) Appl. No.: 11/441,494

(22) Filed: May 26, 2006

(30) Foreign Application Priority Data
Sep. 30, 2005 (CN) 200510100096.X

(51) Int. Cl. H04M 1/00

(52) U.S. Cl. 455/575.3

(57) ABSTRACT

A hinge assembly (100) includes a sleeve (10), a first magnetic member (20), a second magnetic member (20), and a locking member (40). The sleeve is hollow with an open end. The first magnetic member has a first face (242) and a second face (444) at a first end (232) thereof. The first face and the second face have opposing polarities. The second magnetic member is a cylinder. The second magnetic member is received in the sleeve and rotatable relative to the first magnetic member. The second magnetic member has a third face (342) and a fourth face (344) at an end thereof facing the first end of the first magnetic member. The third face and the fourth face have opposing polarities. The locking member is disposed at the open end of the sleeve and fixing connected with sleeve.

### TECHNICAL FIELD

The present invention relates to hinge assemblies and, particularly, to a hinge assembly for foldable electronic devices, such as mobile telephones, electronic notebooks, and the like.

### BACKGROUND

With the development of wireless communication and information processing technologies, portable electronic devices such as mobile telephones and electronic notebooks are now in widespread use. These electronic devices enable consumers to enjoy high technology services anytime and anywhere. Consumers particularly favor foldable electronic devices due to their convenience and ease of storage.

Generally, foldable electronic devices have most of the electronics in one housing, called the body. The other housing, called the flip cover, normally contains fewer electronic components than the body. Other foldable electronic devices have all the electronics in the body, with the flip cover containing no electronics. Various types of hinge assemblies are used to join a body and a cover of a foldable electronic device, so that the flip cover can unfold up from and fold down upon the body. Manufacturers are constantly seeking to reduce the volume, size and weight of portable foldable electronic devices. Thus, it is desirable that the hinge assembly coupling the body with the flip cover is modularized and miniaturized. A modularized hinge assembly has moving parts such as a cam member, a cam follower, a shaft, and a spring, held together in a unified structure. Either the cam member or the cam follower directly contacts the spring. The structure is easily and quickly attached to the body and the flip cover during mass production. The cam member and the cam follower are kept in contact with each other under the force of the spring.

As the cam follower and the cam member are constantly in contact with each other, sliding friction may be produced between the cam member and the cam follower during relative rotation therebetween. This friction wastes energy (i.e. making opening and/or closing of the device more difficult) and causes abrasion of the cam member and the cam follower. The worn surface can further add to the friction therebetween and may eventually lead to premature malfunction or failure of the hinge assembly. In addition, such a hinge assembly can have many components, thus complicating manufacture. Moreover, during the process of opening and closing of the flip cover of the foldable electronic device, the cam member and the cam follower may undergo quick rotation relative to each other under the spring force of the spring, which may produce a large impact on the flip cover. Damage caused by these impacts may eventually lead to premature malfunction or failure of the foldable electronic device. Furthermore, the machining of cam surface of the cam and the cam follower is complicated.

What is needed, therefore, is a hinge assembly which overcomes above-described shortcomings.

### SUMMARY

In a first preferred embodiment, a hinge assembly includes a sleeve, a first magnetic member, a second magnetic member, and a locking member. The sleeve is hollow with an open end. The first magnetic member is a cylinder, and is received in the sleeve and not rotatable relative to the sleeve. The first magnetic member has a first face and a second face at a first end thereof The first face and the second face have opposing polarities. The second magnetic member is a cylinder. The second magnetic member is received in the sleeve and rotatable relative to the first magnetic member. The second magnetic member has a third face and a fourth face at an end thereof facing the first end of the first magnetic member. The third face and the fourth face have opposing polarities. The locking member is disposed at the open end of the sleeve and fixing connected with sleeve.

Other advantages and novel features will become more apparent from the following detailed description when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the present hinge assembly. Moreover, in the drawings like reference numerals designate corresponding parts throughout the several views.

FIG. 1 is an schematic, isometric view of a flip-type mobile phone including a flip cover, a main body, and a hinge assembly, according to a first preferred embodiment, the hinge assembly being shown;

FIG. 2 is an enlarged exploded, isometric view of the hinge assembly of FIG. I including a first magnetic member, and a second magnetic member according to a preferred embodiment;

FIG. 3 is similar to FIG. 2, but shown from another aspect;

FIG. 4 is an assembled view of the hinge assembly shown in FIG. 2;

FIG. 5 shows a first relative position of the first magnetic member and the second magnetic member, where the flip cover is maintained at the fully-closed position;

FIG. 6 shows a plan view of the first magnetic member and the second magnetic member, corresponding to FIG. 5;

FIG. 7 shows a second relative position of the first magnetic member and the second magnetic member;

FIG. 8 shows a third relative position of the first magnetic member and the second magnetic member, and

FIG. 9 shows a fourth relative position of the first magnetic member and the second magnetic member, while the flip cover is maintained at the fully-opened position.

### DETAILED DESCRIPTION OF PREFERRED EMBODIMENTS

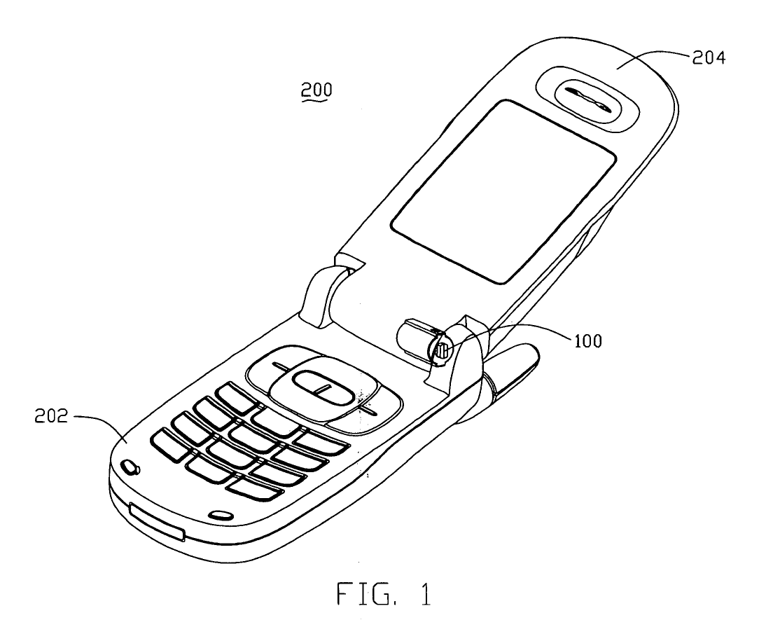

Referring now to the drawings, FIG. 1 shows a foldable electronic device such as a flip-type mobile phone 200, which includes a hinge assembly 100, according to a first preferred embodiment. The mobile phone 200 has a main body 202 and a flip cover 204. The main body 202 and the flip cover 204 are pivotally connected to each other via the hinge assembly 10. It should be noted that the hinge assembly 100 may also, for example, be used to interconnect components like a main body and a flipping section of any other kind of device, other than the mobile phone 200.

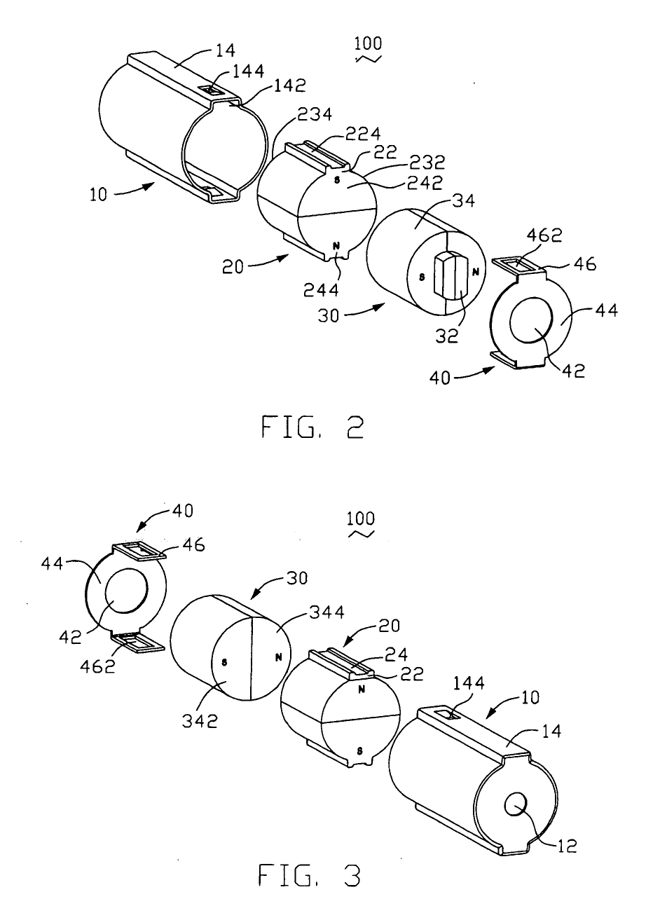

Referring now to FIGS. 2-3, the hinge assembly 100 includes a sleeve 10, a first magnetic member 20, a second magnetic member 30, and a locking member 40.

The sleeve 10 is a hollow cylinder with an open end. The other end of the sleeve 10 defines a hole 12 therein. The sleeve 10 has two symmetrical protruding walls 14 protruding from an outer periphery thereof and extending along an axial direction. The protruding walls 14 are recessed from an inner periphery of the sleeve 10 to form two sliding grooves 142 in the inner periphery. Two wedge-shaped latching blocks 144 are respectively disposed on an inner surface of the protruding walls 14 and adjacent the open end, for latching the locking member 40. The sleeve 10 is connected with the flip cover 202 via the protruding walls 14.

The first magnetic member 20 is an integrally formed cylinder. A diameter of the first magnetic member 20 is equal to or slightly less than an inner diameter of the sleeve 10 such that the first magnetic member 20 is received in the sleeve 10. The first magnetic member 20 has two symmetrical protrusions 22 formed on an outer periphery thereof and extending along an axis direction thereof, for engaging in the sliding grooves 142. Each protrusion 22 has a longitudinal recess 224, for containing the latching blocks 144 of the sleeve 10. The first magnetic member 20 has a first end 232 and a second end 234. Each one of the first end 232 and the second end 234 of the first magnetic member 20 can be divided into two or more faces. The adjacent faces of the first magnetic member 20 have opposing polarities. For example, in this embodiment, the first end 232 of the first magnetic member 20 is divided into a first face 242, and a second face 244. The first face 242 of the first magnetic member 20 forms a north (N) magnetic pole, and the second face 244 forms south (S) magnetic pole. Since a magnetic member has a north and a south magnetic poles, the second end 234 of the first magnetic member 20 has two faces having opposing magnetic poles, with south and north corresponding to the first face 242, and the second face 244, respectively.

The second magnetic member 30 is an integrally formed cylinder. The second magnetic member 30 includes a securing portion 32 and a cylinder portion 34 connecting with the securing portion 32. The securing portion 32 is connected with the body 204 of the mobile phone 200. A diameter of the cylinder portion 34 is equal to or slightly less than the inner diameter of the sleeve 10 such that the cylinder portion 34 of the second magnetic member 30 is received in the sleeve 10. One end of the cylinder portion 34 also can be divided into two or more faces. The adjacent faces of the second magnetic member 30 have opposing polarities. For example, in this embodiment, an end of the cylinder portion 34 facing to the first end 232 of the first magnetic member 10 is divided into a third face 342, and a fourth face 344. The third face 342 of the second magnetic member 30 forms a north (N) magnetic pole, and the fourth face 344 forms a south (S) magnetic pole.

The locking member 40 includes a sheet-like portion 44 with a central hole 42, and two opposing locking arms 46 extending in parallel in the same direction from an outer periphery of the sheet-like portion. The securing portion 32 of the second magnetic member 30 can pass through the central hole 42. Each locking arm 46 defines a rectangular opening 462 such that each latching block 144 can securely engage in a corresponding opening 462.

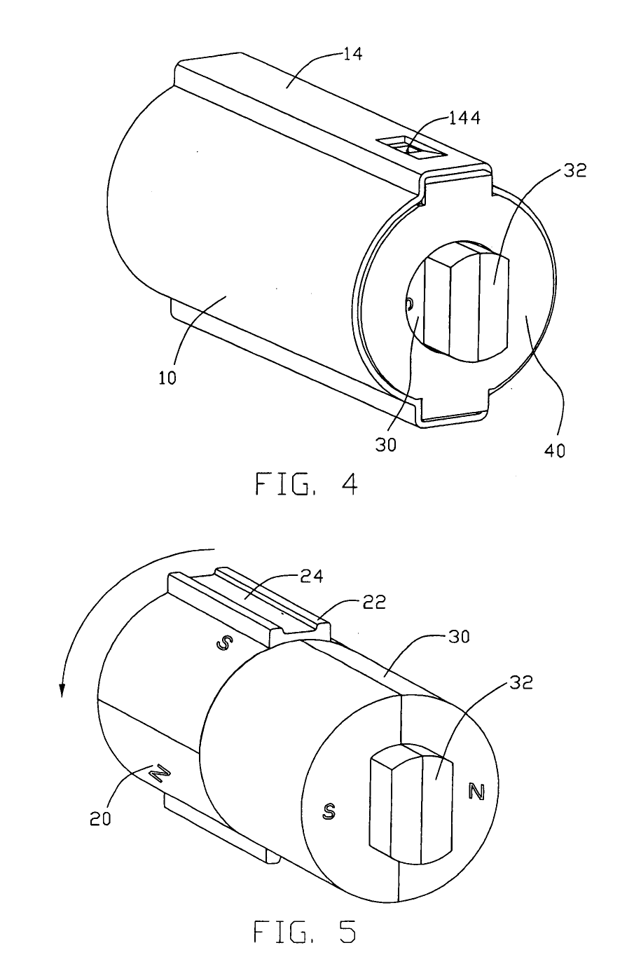

Referring to FIG. 4, in assembly, the first magnetic member 20 and the second magnetic member 30 are received in the sleeve 10, with the latching blocks 144 of the sleeve 10 contained in the recess 24 of the first magnetic member 20 and the securing portion 32 of the second magnetic member 30 exposed out of the open end of the sleeve 10. The locking member 40 covers the open end of the first sleeve 10, with the securing portion 32 of the second magnetic member 30 extending through the central hole 42 of the locking member 40. The latching blocks 144 of the sleeve 10 are securely engaged in the openings 462, thus for preventing the first magnetic member 20 and the second magnetic member 30 from becoming separated from the first magnetic member 10.

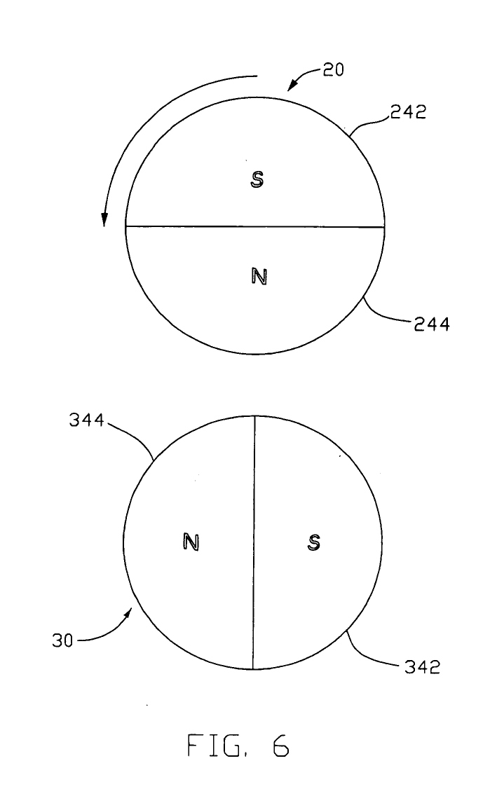

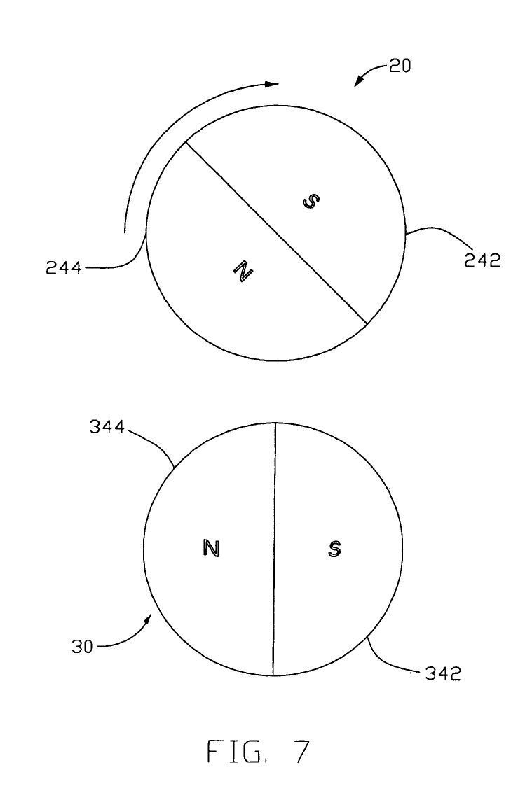

Referring to FIG. 4, in use, the sleeve 10 is engaged (i.e. operatively located/fixed) in a cavity (not shown) of the flip cover 204 of the mobile phone 200 via the protruding walls 14, and cannot rotate relative to the flip cover 204. The securing portion 32 of the second magnetic member 30 is engaged in the main body 202 of the mobile phone 200, and cannot rotate relative to the main body 202. FIG. 5 shows a first relative position of the first magnetic member 20 and the second magnetic member 30, while the flip cover 204 is in a fully-closed position relative to the main body 202. In this state, the first face 242, the third face 342, the second face 244 and the fourth face 344 are arranged so as to be separated by 90-degree angles from each other. Meanwhile, the magnetic forces, as denoted by the direction of the arrow in FIG. 5, give the first magnetic member 10 a tendency to rotate relative to the second magnetic member 20 in a counter-clock wise direction, as denoted by the direction of the arrow in FIG. 6, which maintains the flip cover 204 in a fully-closed position relative to the main body 202.

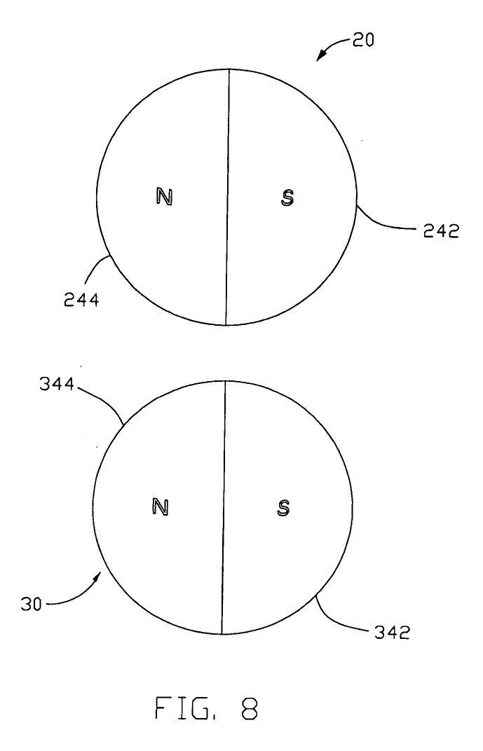

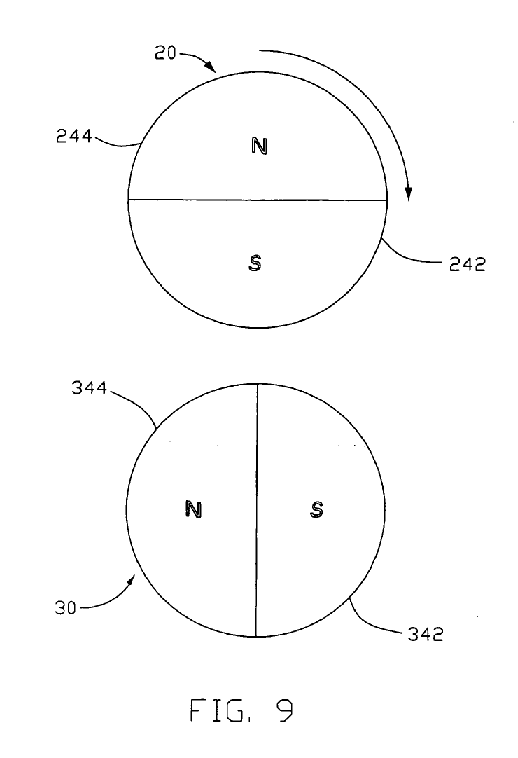

Referring to FIG. 7, if a user opens the flip cover 204 to rotate the first magnetic member 20 in clockwise direction, as denoted by the direction of the arrow in FIG. 7, the first face 242 will approach the third face 342 and move away from the fourth face 344. If the external force is removed, the repulsive force (between the first face 242 and the third face 342, and between the second face 244 and the fourth face 344) will drive the first face 242 back to the state of FIG. 6. If the first magnetic member 20 keeps rotating to 90 degrees as shown in FIG. 8, the first face 242 and the third face 342, the second face 244 and the fourth face 344, having the same polarity are disposed facing in approximately the same direction. Meanwhile, the repulsive force forces the first magnetic member 10 and the second magnetic member 20 to reach the maximum unstable state. If any force imbalance occurs, the first magnetic member 10 will be repelled to the clockwise or counterclockwise direction. Accordingly, 90-degree is a critical angle in the preferred embodiment.

If an external force is continuously applied to the first magnetic member 20 to rotate the first magnetic member 10 through a critical angle as shown in FIG. 8, then the first face 242 is repelled by the third face 342 and attracted by the fourth face 344. If the external force is terminated right now, then the first magnetic member 20 automatically keep rotating until the first face 242, the third face 342, the second face 244 and the fourth face 344 are arranged so as to be separated by 90-degree angles from each other again as shown FIG. 9. The flip cover 204 is therefore rotated to a fully-opened position. In this state, the magnetic forces, as denoted by the direction of the arrow in FIG. 9, give the first magnetic member 20 a tendency to rotate relative to the second magnetic member 30 in a clockwise direction as shown in FIG. 8. The structures of the flip cover 204 and the main body 202 can therefore control the range of rotation of the hinge assembly 100, such that the first magnetic member 20 is located at a 180-degree position.

In an alternative embodiment, each locking arm 46 may be designed to have a locking blocks protruding therefrom, the sleeve 10 also having two spaced openings defined in an outer periphery thereof Each locking blocks of the locking arm 46 being configured to engage in a corresponding opening of the first magnetic member 20. In addition, the locking member 40 can be omitted. The first magnetic member 20 and the second magnetic member 30 may be prevented from becoming separated from the sleeve 10 via the main body 202 of the mobile phone 200. The protruding walls 14 may be replaced by other fixing portion such as protrusion or groove formed on an outer periphery of the sleeve 10.

In the aforementioned description, the first and the second magnetic member 20, 30 of the present hinge assembly could be chosen from the group consisting of permanent magnets, electromagnets, or other materials possessing magnetism.

In the embodiments described above, a main advantage is that it has few main components, and occupies a relatively small volume. Accordingly, the space required in an application such as a mobile phone 200 is reduced. In addition, when the second magnetic member 30 is received in the sleeve 10, there may be a space between the sleeve 10 and the second magnetic member 30, and between the first magnetic member 20 and the second magnetic member 30, so that no sliding friction is produced between the sleeve 10, the first magnetic member 20 and the second magnetic member 30. The magnetic material adopted in the embodiment does not wear out easily with time and has no issue of elasticity decay and as a result the durability of the hinge assembly is greatly increased.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A hinge assembly, comprising:
a sleeve being hollow with an open end;
a first magnetic member being a cylinder, the first magnetic member being received in the sleeve and not rotatable relative to the sleeve, the first magnetic member having a first face and a second face at a first end thereof, the first face and the second face having opposing polarities;
a second magnetic member being a cylinder, the second magnetic member being received in the sleeve and rotatable relative to the first magnetic member, the second magnetic member having a third face and a fourth face at an end thereof facing the first end of the first magnetic member, the third face and the fourth face having opposing polarities, and
a locking member disposed at the open end of the sleeve and fixingly connected with the sleeve.

2. The hinge assembly as claimed in claim 2, wherein the locking member includes a sheet-like portion covering a portion of the open end of the sleeve.

3. The hinge assembly as claimed in claim 2, wherein the locking member further comprises two spaced locking arms extending from an outer periphery of the sheet-like portion.

4. The hinge assembly as claimed in claim 3, wherein each locking arm defines an opening, the sleeve has two spaced latching blocks protruding from an outer periphery thereof, wherein each latching block engages in a corresponding opening of the locking arm.

5. The hinge assembly as claimed in claim 4, wherein each locking arm has a plurality of locking blocks protruding therefrom, the sleeve has two spaced openings defined in an outer periphery thereof, and each locking block of the locking arm engages in a corresponding opening of the first magnetic member.

6. The hinge assembly as claimed in claim 1, wherein the first magnetic member and the second magnetic member are integrally formed.

7. The hinge assembly as claimed in claim 1, wherein the first magnetic member and the second magnetic member are chosen from the group consisting of magnets, permanent magnets, or electromagnets.

8. A hinge assembly for a foldable electronic device having a main body and a flip cover, the hinge assembly comprising:
a sleeve being hollow with an open end, the sleeve being configured so as to be fixed relative to one of the main body and the flip cover;
a first magnetic member being integrally formed, the first magnetic member received in the sleeve and not rotatable relative to the sleeve, the first magnetic member having a first face and a second face at a first end thereof, the first face and the second face having opposing polarities;
a second magnetic member being integrally formed with a securing portion formed at one end thereof, the second magnetic member received in the sleeve and rotatable relative to the first magnetic member, the second magnetic member having a third face and a fourth face at the other end thereof facing the first end of the first magnetic member, the third face and the fourth face having opposing polarities, the securing portion being configured so as to be fixed relative to the other of the main body and the flip cover;

9. The hinge assembly as claimed in claim 8, further comprising a locking member disposed at the open end of the first magnetic member so as to prevent the second magnetic member from becoming separated from the first magnetic member.

10. The hinge assembly as claimed in claim 9, wherein the locking member includes a sheet-like portion covering the open end of the first magnetic member.

11. The hinge assembly as claimed in claim 10, wherein the locking member further comprises two spaced locking arms extending from an outer periphery of the sheet-like portion.

12. The hinge assembly as claimed in claim 10, wherein each locking arm defines an opening, the sleeve has two spaced locking blocks protruding from an outer periphery thereof, and each locking block engages in a corresponding opening of the locking arm.

13. The hinge assembly as claimed in claim 10, wherein each locking arm has a plurality of locking blocks protruding therefrom, the sleeve has two spaced opening defined in an outer periphery thereof, and each locking block of the locking arm engages in one corresponding opening of the sleeve.

14. The hinge assembly as claimed in claim 8, wherein the second magnetic member has a fixing portion formed on an outer periphery thereof, the fixing portion being configured so as to be fixed with the one of the main body and the flip cover.

14. The hinge assembly as claimed in claim 13, wherein the fixing portion includes two protruding walls protruding from an outer periphery of the sleeve.

15. A foldable electronic device, comprising:
a main body;
a flip cover; and
a hinge assembly joining the flip cover to the main body, the hinge assembly including:
a sleeve being hollow with an open end;
a first magnetic member being a cylinder, the first magnetic member received in the sleeve and not rotatable relative to the sleeve, the first magnetic member having a first face and a second face at a first end thereof, the first face and the second face having opposing polarities;
a second magnetic member being a cylinder, the second magnetic member received in the sleeve and rotatable relative to the first magnetic member, the second magnetic member having a third face and a fourth face at an end thereof facing the first end of the first magnetic member, the third face and the fourth face having opposing polarities; and
a locking member covering the open end of the sleeve and connected with the sleeve.

16. The hinge assembly as claimed in claim 15, wherein the locking member includes a sheet-like portion covering a portion of the open end of the sleeve.

17. The hinge assembly as claimed in claim 16, wherein the locking member further comprises two spaced locking arms extending from an outer periphery of the sheet-like portion.

18. The hinge assembly as claimed in claim 16, wherein each locking arm defines an opening, the sleeve has two spaced latching blocks protruding from an outer periphery thereof, and each latching block engages in the one corresponding opening of the locking arm.

19. The hinge assembly as claimed in claim 15, wherein the first magnetic member and the second magnetic member are integrally formed.
